(19) United States
(12) Patent Application Publication
(10) Pub. No.: US 2022/0020088 A1
(43) Pub. Date: Jan. 20, 2022

(54) DEVICE AND METHOD FOR ASSIGNING VIRTUAL OBJECT RECORDING ELECTRONIC VOUCHER BASED ON BLOCK CHAIN

(71) Applicant: HON HAI PRECISION INDUSTRY CO., LTD., New Taipei (TW)

(72) Inventor: Chun-Wei CHIU, New Taipei (TW)

(21) Appl. No.: 17/372,732

(22) Filed: Jul. 12, 2021

(30) Foreign Application Priority Data
Jul. 17, 2020 (CN) 202010693850.X

(51) Int. Cl. G06Q 40/04; G06Q 20/38

(52) U.S. Cl. CPC G06Q 40/04; G06Q 20/3821; G06Q 20/389

(57) ABSTRACT

A method for assigning virtual object in a block chain system obtains an amount of virtual currency owned by each block chain account, and assigns a number of electronic vouchers to each block chain account based on the amount of virtual currency owned by each block chain account. Special electronic vouchers with authority of reward distribution according to a predetermined extraction rule are determined, and virtual currency is assigned to each block chain account based on the number of special electronic vouchers owned by each block chain account. A device for assigning virtual object is also provided.

### FIELD

The subject matter herein generally relates to verification by block chain.

### BACKGROUND

Block chain technology provides distributed data storage, point-to-point transmission, a consensus mechanism, and encryption algorithms. The block chain technology employs a consensus mechanism such as Proof of Work to achieve validation of a block in a chain. A mathematical algorithm can establish rights between different nodes in the block chain system. In block chain technology, a sale mode of a virtual currency is in form of first-come, first-served. A total sales volume of virtual currency depends on a potential value of the virtual currency.

Thus, there is room for improvement.

### BRIEF DESCRIPTION OF THE DRAWINGS

Implementations of the present disclosure will now be described, by way of embodiments, with reference to the attached figures.

FIG. 1 illustrates a block view of an embodiment of a block chain system.

FIG. 2 illustrates a block view of an embodiment of a device for assigning virtual object utilizing the block chain system of FIG. 1.

FIG. 3 illustrates a block view of an embodiment of a procedure for assigning virtual object of the device of FIG. 2.

FIG. 4 illustrates a flowchart of an embodiment of a method for assigning virtual object utilizing the block chain system of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure. It should be noted that references to “an” or “one” embodiment in this disclosure are not necessarily to the same embodiment, and such references mean “at least one”.

Several definitions that apply throughout this disclosure will now be presented.

The connection can be such that the objects are permanently connected or releasably connected. The term “comprising,” when utilized, means “including, but not necessarily limited to”; it specifically indicates open-ended inclusion or membership in the so-described combination, group, series, and the like.

FIG. 1 illustrates a block view of an embodiment of a block chain system. The block chain system 1 comprises a block chain network and a block chain. The block chain network includes a number of nodes. Each node records and saves account balances and block chain addresses of multiple block chain accounts. Users, for example block chain users, employ a unique block chain address to represent their identity and associated funds, and employs a set of public keywords and private keywords to identify themselves and protect their funds. Each block chain user can use a client terminal, for example, a computer, a smart phone, or the like, to communicate and interact with any other node. For example, the block chain user can communicate with any node through a webpage or an application of a smart phone.

In FIG. 1, the block chain network comprises four nodes, respectively A, B, C, and D. However, the number of the nodes is not limited to four, the block chain network can include more nodes.

In can be understood that, each node takes account of the blocks based on the consensus mechanism. When any node broadcasts information or the block to the block chain network, the other nodes receive and verify the received block. When a ratio of a quantity of verified nodes to a quantity of total nodes in the block chain network is greater than a predetermined threshold, the verification of the block chain network to the block is determined to be passed, and all nodes can accept and take account of the block.

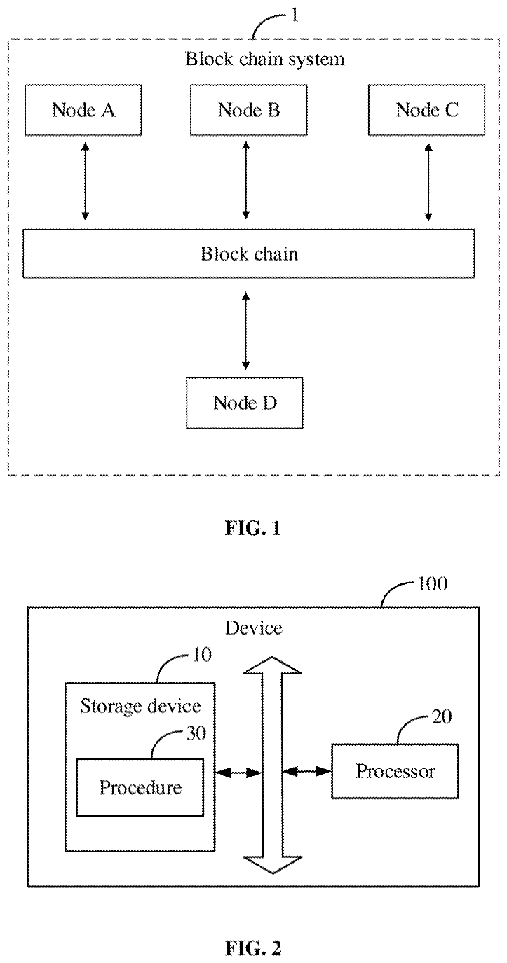

FIG. 2 illustrates a block view of an embodiment of a device for assigning virtual object based on the block chain system.

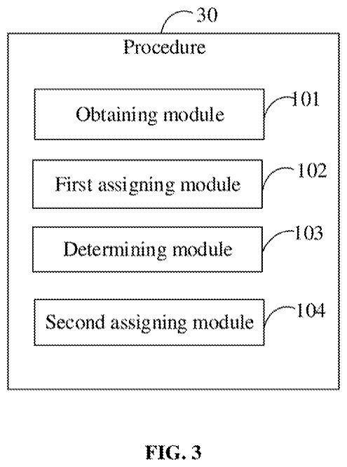

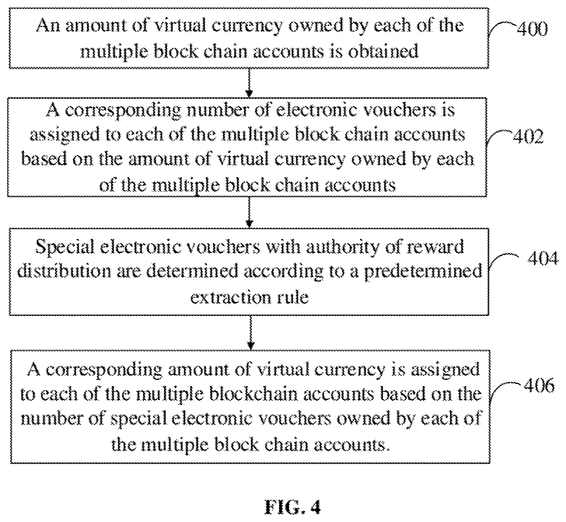

In one embodiment, the device 100 can comprise a storage device 10, at least one processor 20, and a procedure for assigning virtual object (procedure 30) stored in the storage device 10. The procedure 30 can be run on the at least one processor 20. The at least one processor 20 can execute the procedure 30 to accomplish the steps of a method for assigning virtual object, for example, the steps 400-406 of FIG. 4. The at least one processor 20 can alternatively execute the procedure 30 to accomplish the function of the modules of the procedure 30, for example, to accomplish the function of the modules 101-104 of FIG. 3.

The procedure 30 can be divided into one or more modules/units. The one or more modules/units can be stored in the storage device 10 and executed by the at least one processor 20. The one or more modules/units can be a series of program instruction segments, which can perform specific functions, and the instruction segment is configured to describe the execution process of the procedure 30 in the device 100. For example, the procedure 30 can be divided into an obtaining module 101, a first assigning module 102, a determining module 103, and a second assigning module 104, as shown in FIG. 3. The detail function of each module is described in FIG. 3.

It can be understood that, the block view exemplified in FIG. 2 is an example of the device 100. The block view is not to be considered as limiting the device 100. Additional components can be added, or fewer components can be utilized, or some components can be combined, or different components can be used without departing from this disclosure. For example, the device 100 may comprise a display device, a network accessing device, a bus, or the like.

The at least one processor 20 can be one or more central processing units, or it can be one or more other universal processors, digital signal processors, application specific integrated circuits, field-programmable gate arrays, or other programmable logic devices, discrete gate or transistor logic, discrete hardware components, and so on. The at least one processor 20 can be a microprocessor or any regular processor, or the like.

The storage device 10 stores the procedure 30 and/or modules/units. The at least one processor 20 can run or execute the procedure 30 and/or modules/units stored in the storage device 10, and accomplish the various functions of the device 100. In addition, the storage device 10 can include a non-transitory storage medium, such as hard disk, memory, plug-in hard disk, smart media card, secure digital, flash card, at least one disk storage device, flash memory, or other transitory storage medium.

FIG. 3 illustrates a block view of an embodiment of the procedure 30.

The procedure 30 can comprise the obtaining module 101, the first assigning module 102, the determining module 103, and the second assigning module 104. In one embodiment, the modules can be stored in the storage device 10 and can be run on the at least one processor 20. It can be understood that, in other embodiments, the modules can be instructions or firmware resident in the at least one processor 20.

The obtaining module 101 can find and analyze an amount of virtual currency owned by each of multiple block chain accounts.

In one embodiment, a block chain user can register on a cryptocurrency platform that issued the virtual currency and obtain a unique block chain account. When the block chain user completes a verification of know your customer (KYC) and a verification of anti-money laundering (AML), the block chain user can inject funds into the block chain account for purchasing the virtual currency. The obtaining module 101 can find the amount of virtual currency owned by each of the multiple block chain accounts.

The first assigning module 102 can assign a corresponding number of electronic vouchers to each of the multiple block chain accounts based on the amount of virtual currency owned by each of the multiple block chain accounts.

In one embodiment, when the amount of virtual currency owned by each of the multiple block chain accounts is known, the first assigning module 102 can assign a number of electronic vouchers to each of the multiple block chain accounts based on the amount of virtual currency owned by each of the multiple block chain accounts. The number of electronic vouchers that can be assigned to a single block chain account is determined by the amount of virtual currency it owns.

For example, a block chain account with 0 to 99 pieces of virtual currency can be assigned 0 (zero) electronic vouchers, a block chain account with 100 to 199 pieces of virtual currency can be assigned one electronic voucher, a block chain account with 200 to 299 pieces of virtual currency can be assigned two electronic vouchers, a block chain account with 300 to 399 pieces of virtual currency can be assigned three electronic vouchers, and a block chain account with 400 to 499 pieces of virtual currency can be assigned four electronic vouchers.

In one embodiment, the number of electronic vouchers that can be assigned to each block chain account has an upper limit. The maximum number of electronic vouchers that can be assigned to a block chain account is fixed, so the number of electronic vouchers assigned to each of the multiple block chain accounts is not more than a predetermined value. The predetermined value can be defined according to an actual application. For example, the predetermined value can be defined as five electronic vouchers, each of the multiple block chain accounts can be assigned a maximum of five electronic vouchers. If a block chain account comprises at least or more than 500 pieces of virtual currency, five electronic vouchers can be assigned to the first block chain account, which makes the block chain account own more virtual currency, and opportunities for reward distribution of the block chain account does not increase indefinitely.

In one embodiment, a distribution rule of the first assigning module 102 assigning a corresponding number of electronic vouchers to each of the multiple block chain accounts can comprise: assigning the corresponding number of electronic vouchers to each of the multiple block chain accounts based on a maximum of virtual currency recorded as owned by each of the multiple block chain accounts in a predetermined time period.

In one embodiment, the obtaining module 101 obtains the record of maximum virtual currency owned by each of the multiple blockchain accounts in the predetermined time period, and the first assigning module 102 assigns the corresponding number of electronic vouchers to each of the multiple block chain accounts based on the maximum owning record of virtual currency owned by each of the multiple block chain accounts in the predetermined time period. The predetermined time period can be defined according to the actual application. For example, the predetermined time period is within the first 10-days of determining special electronic vouchers with authority of reward distribution, or within the first 12-days of determining the special electronic vouchers with authority of reward distribution.

In one embodiment, the special electronic vouchers are selected from all the assigned electronic vouchers, the authority of reward distribution of each special electronic voucher can exchange a predetermined amount of virtual currency.

In one embodiment, the electronic voucher can be any form of virtual voucher which can be exchanged for virtual currency. The form of the electronic voucher is not limited, such as a string, a number, a character, a password, a virtual card, etc.

For example, the electronic voucher is an electronic lottery. Within 10 days before the electronic lottery draw, the number of electronic lottery that can be assigned to a block chain account is determined by the record of maximum virtual currency owned by the block chain account. A maximum of 250 pieces of virtual currency is recorded as being owned by block chain account A1 in 10 days before the electronic lottery draw, and the first distribution module 102 assigns two electronic lotteries to the block chain account A1. Even if the amount of virtual currency owned by block chain account A1 is reduced to 99 pieces in two or three days before the electronic lottery draw, the block chain account A1 can also be assigned to two electronic lotteries. A maximum of virtual currency owned by block chain account A2 in 10 days before the electronic lottery draw is 550 pieces of virtual currency, and the first distribution module 102 assigns five electronic lotteries to the block chain account A2.

In one embodiment, the electronic vouchers can be encrypted by a predetermined encryption algorithm before the first distribution module 102 assigns the electronic vouchers to each of the multiple block chain accounts. When the block chain account receives the encrypted electronic vouchers, the encrypted electronic vouchers can be deciphered according to a decryption algorithm corresponding to the predetermined encryption algorithm.

The determining module 103 can determine the special electronic vouchers with authority of reward distribution according to a predetermined extraction rule.

In one embodiment, the number of the special electronic vouchers can be defined according to actual demand. Each of the special electronic vouchers is configured to be exchangeable for the virtual currency. For example, the number of the special electronic vouchers is a fixed number, or there can be a relationship of fixed proportionality with the total number of issued electronic vouchers.

For example, 1% of the electronic vouchers are defined as the special electronic vouchers. If 10,000 of electronic vouchers are assigned to the multiple block chain accounts, the determining module 103 extracts 100 of special electronic vouchers from 10,000 of electronic vouchers according to a predetermined extraction rule. The predetermined extraction rule may be to randomly determine the special electronic vouchers with the authority of reward distribution from the issued electronic vouchers through a predetermined random number generator. The predetermined random number generator may use a predetermined random number generation algorithm, such as a hybrid random number generation algorithm. Each of the electronic vouchers comprises a unique serial number, the serial numbers of the issued electronic vouchers can be arranged in sequence. The determining module 103 extracts one or more serial numbers with the authority of reward distribution according to the predetermined random number generation algorithm, and defines electronic vouchers which comprise extracted serial numbers as the special electronic vouchers.

In one embodiment, the determining module 103 can calculate a hash value of each of the electronic vouchers, and extracts one or more hash values with the authority of reward distribution according to the predetermined random number generation algorithm. The determining module 103 further defines electronic vouchers corresponding to extracted hash values as the special electronic vouchers.

In one embodiment, when a block chain account owns one or more special electronic vouchers, this indicates that the block chain account obtains a distribution authority of virtual currency reward.

The second assigning module 104 can assign a corresponding amount of virtual currency to each of the multiple blockchain accounts based on the number of special electronic vouchers owned by each of the multiple block chain accounts.

In one embodiment, the amount of virtual currency for which each of the special electronic vouchers is exchangeable can be determined according to a predetermined distribution rule. For example, the predetermined distribution rule is that each of the special electronic vouchers exchanges a predetermined amount of virtual currency, the predetermined amount can be set according to the actual demand, such as the predetermined amount being 100 pieces. Each of the special electronic vouchers can be exchanged for 100 pieces of virtual currency. If the block chain account A1 comprises two special electronic vouchers, the second assigning module 104 assigns 200 pieces of virtual currency to the block chain account A1. If the block chain account A2 comprises one special electronic voucher, the second assigning module 104 assigns 100 pieces of virtual currency to the block chain account A2. If a block chain account A3 does not comprise a special electronic voucher, the second assigning module 104 assigns nil value, no virtual currency, to the block chain account A3.

In one embodiment, a predetermined virtual currency set can be preestablished, and the virtual currency in the predetermined virtual currency set is assigned to each of the special electronic vouchers. The amount of virtual currency in the predetermined virtual currency set can be fixed based on the actual demand. For example, the predetermined virtual currency set can comprise a fixed value (such as 1,000 pieces) of the virtual currency, or a dynamic value of the virtual currency according to the total number of issued electronic vouchers. The second assigning module 104 can calculate a reward distribution ratio of each of the multiple block chain accounts in the predetermined virtual currency set based on the number of special electronic vouchers owned by each of the multiple block chain accounts. The second assigning module 104 assigns the corresponding amount of virtual currency to each of the multiple blockchain accounts based on the reward distribution ratio of each of the multiple block chain accounts in the predetermined virtual currency set.

For example, the predetermined virtual currency set comprises 1,000 pieces of virtual currency, and the number of the special electronic vouchers is 100 pieces. If the block chain account A1 comprises two special electronic vouchers, the block chain account A1 can be assigned 2% of the virtual currency in the predetermined virtual currency set (20 pieces of virtual currency). If the block chain account A2 comprises one special electronic voucher, the block chain account A2 can be assigned 1% of the virtual currency in the predetermined virtual currency set (10 pieces of virtual currency).

The second assigning module 104 may also calculate an average assigning value of the virtual currency in the predetermined virtual currency set based on the number of the special electronic vouchers. For example, the average assigning value of the virtual currency in the predetermined virtual currency set is 10 pieces of virtual currency (1,000/100). That is, each of the special electronic vouchers can be exchanged for 10 pieces of virtual currency.

In one embodiment, each of the special electronic vouchers corresponds to one reward distribution request. The second assigning module 104 may assign a random amount of virtual currency from the predetermined virtual currency set to each of the multiple block chain accounts based on the reward distribution request. For example, the block chain account A1 comprises two special electronic vouchers, the second assigning module 104 can randomly extract an amount of virtual currency for the block chain account A1 from the predetermined virtual currency set. The second assigning module 104 may generate a random value for the block chain account A1 based on a predetermined random algorithm combined with the total number of issued electronic vouchers. The second assigning module 104 assigns the random value of virtual currency to the block chain account A1 based on the one reward distribution request. If the block chain account A1 comprises two special electronic vouchers, the second assigning module 104 performs two random extractions and assignations.

In one embodiment, when the second assigning module 104 assigns an amount of virtual currency to each of the multiple block chain accounts based on the number of special electronic vouchers owned by each of the multiple block chain accounts, each node in the block chain system 1 can verify and confirm a virtual currency assignation operation.

For example, the block chain system 1 comprises the four nodes A˜D, each node A˜D can verify the virtual currency assignation operation. When there is verification of any node in the block chain system 1 to the virtual currency assignation operation, a verification information is broadcast to the other nodes. For example, the virtual currency assignation operation to the node A is verified, the node A may broadcast the verification information to the other modes B-D, and the node A can also receive the verification broadcast from the other nodes B-D.

In one embodiment, the block chain network can reach a consensus as to the virtual currency assignation operation when the quantity of verifications received by the node is greater than a first predetermined value. The node may take account of the block generated in the virtual currency assignation operation.

For example, when the quantity of verifications received by the node A is greater than the first predetermined value, and the block chain network reaches a consensus as to the virtual currency assignation operation, the node A can save a block generated in the virtual currency assignation operation. When the quantity of verifications received by the node B is greater than the first predetermined value, and the block chain network reaches a consensus as to the virtual currency assignation operation, the node B can save the block generated in the virtual currency assignation operation.

In one embodiment, the first predetermined value can be set according to the consensus mechanism. For example, the first predetermined value can be set to be ⅔ of the total nodes.

In one embodiment, the block chain system 1 can comprise a master node and multiple slave nodes, and each node can perform block accounting through a block synchronization mechanism.

In one embodiment, when a block chain account initiates a virtual currency transaction, each node in the block chain system 1 can also verify and confirm the transaction.

FIG. 4 illustrates one exemplary embodiment of a method for assigning virtual object based on a block chain system. The flowchart presents an exemplary embodiment of the method. The exemplary method is provided by way of example, as there are a variety of ways to carry out the method. The method described below can be carried out using the configurations illustrated in FIG. 3, for example, and various elements of these figures are referenced in explaining the example method. Each block shown in FIG. 4 may represent one or more processes, methods, or subroutines, carried out in the example method. Furthermore, the illustrated order of blocks is illustrative only and the order of the blocks can change. Additional blocks can be added or fewer blocks may be utilized, without departing from this disclosure. The example method can begin at block 400.

In block 400, an amount of virtual currency owned by each of multiple block chain accounts is obtained.

In one embodiment, the block chain system 1 can comprise the multiple block chain accounts. The obtaining module 101 can obtain the amount of virtual currency owned by each of the multiple block chain accounts.

In block 402, a corresponding number of electronic vouchers is assigned to each of the multiple block chain accounts based on the amount of virtual currency owned by each of the multiple block chain accounts.

In one embodiment, the first assigning module 102 can assign the corresponding number of electronic vouchers to each of the multiple block chain accounts based on the amount of virtual currency owned by each of the multiple block chain accounts.

In block 404, special electronic vouchers with authority of reward distribution are determined according to a predetermined extraction rule.

In one embodiment, the determining module 103 can determine the special electronic vouchers with the authority of reward distribution according to the predetermined extraction rule.

In block 406, a corresponding amount of virtual currency is assigned to each of the multiple blockchain accounts based on the number of special electronic vouchers owned by each of the multiple block chain accounts.

In one embodiment, the second assigning module 104 can assign the corresponding amount of virtual currency to each of the multiple blockchain accounts based on the number of special electronic vouchers owned by each of the multiple block chain accounts.

The embodiments shown and described above are only examples. Many details known in the relevant field are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will, therefore, be appreciated that the embodiments described above may be modified within the scope of the claims.

What is claimed is:

1. A method for assigning virtual object based on a block chain system, the block chain system comprising multiple block chain accounts, the method comprising:
obtaining an amount of virtual currency owned by each of the multiple block chain accounts;
assigning a corresponding number of electronic vouchers to each of the multiple block chain accounts based on the amount of virtual currency owned by each of the multiple block chain accounts;
determining special electronic vouchers with authority of reward distribution according to a predetermined extraction rule, wherein each of the special electronic vouchers is configured to exchange the virtual currency; and
assigning a corresponding amount of virtual currency to each of the multiple block chain accounts based on the number of special electronic vouchers owned by each of the multiple block chain accounts.

2. The method of claim 1, wherein obtaining the amount of virtual currency owned by each of the multiple block chain accounts comprises:
obtaining a record of maximum virtual currency owned by each of the multiple block chain accounts in a predetermined time period.

3. The method of claim 2, wherein assigning the corresponding number of electronic vouchers to each of the multiple block chain accounts based on the amount of virtual currency owned by each of the multiple block chain accounts comprises:
assigning the corresponding number of electronic vouchers to each of the multiple block chain accounts based on the record of maximum virtual currency owned by each of the multiple block chain accounts in the predetermined time period.

4. The method of claim 1, wherein the number of electronic vouchers assigned to each of the multiple block chain accounts is less than or equal to a predetermined value.

5. The method of claim 1, wherein each of the special electronic vouchers is configured to exchange a predetermined amount of virtual currency.

6. The method of claim 1, wherein assigning the corresponding amount of virtual currency to each of the multiple block chain accounts based on the number of special electronic vouchers owned by each of the multiple block chain accounts comprises:
calculating a reward distribution ratio of each of the multiple block chain accounts in a predetermined virtual currency set based on the number of special electronic vouchers owned by each of the multiple block chain accounts; and
assigning the corresponding amount of virtual currency to each of the multiple block chain accounts based on the reward distribution ratio of each of the multiple block chain accounts.

7. The method of claim 1, wherein each of the special electronic vouchers corresponds to one reward distribution request, wherein assigning the corresponding amount of virtual currency to each of the multiple block chain accounts based on the number of special electronic vouchers owned by each of the multiple block chain accounts comprises:
assigning a random amount of virtual currency from a predetermined virtual currency set to each of the multiple block chain accounts based on the reward distribution request.

8. The method of claim 1, wherein each of at special electronic vouchers comprise a unique serial number, wherein determining the special electronic vouchers with the authority of reward distribution according to the predetermined extraction rule comprises:
extracting one or more serial numbers with the authority of reward distribution according to a predetermined random number generation algorithm; and
defining electronic vouchers comprised extracted serial numbers as the special electronic vouchers.

9. The method of claim 8, wherein determining the special electronic vouchers with the authority of reward distribution according to the predetermined extraction rule comprises:
calculating a hash value of each of the electronic vouchers;
extracting one or more hash values with the authority of reward distribution according to a predetermined random number generation algorithm; and
defining electronic vouchers corresponding to extracted hash values as the special electronic vouchers.

10. A device for assigning virtual object based on a block chain system, the block chain system comprising multiple block chain accounts, the device comprising:
a storage device; and
at least one processor;
wherein the storage device stores one or more programs, which when executed by the at least one processor, cause the at least one processor to:
obtain an amount of virtual currency owned by each of the multiple block chain accounts;
assign a corresponding number of electronic vouchers to each of the multiple block chain accounts based on the amount of virtual currency owned by each of the multiple block chain accounts;
determine special electronic vouchers with authority of reward distribution according to a predetermined extraction rule, wherein each of the special electronic vouchers is configured to exchange the virtual currency; and
assign a corresponding amount of virtual currency to each of the multiple block chain accounts based on the number of special electronic vouchers owned by each of the multiple block chain accounts.

11. The device of claim 10, wherein the at least one processor obtaining the amount of virtual currency owned by each of the multiple block chain accounts comprises:
obtaining a record of maximum virtual currency owned by each of the multiple block chain accounts in a predetermined time period.

12. The device of claim 11, wherein the at least one processor assigning the corresponding number of electronic vouchers to each of the multiple block chain accounts based on the amount of virtual currency owned by each of the multiple block chain accounts comprises:
assigning the corresponding number of electronic vouchers to each of the multiple block chain accounts based on the record of maximum virtual currency owned by each of the multiple block chain accounts in the predetermined time period.

13. The device of claim 10, wherein the number of electronic vouchers assigned to each of the multiple block chain accounts is less than or equal to a predetermined value.

14. The device of claim 10, wherein each of the special electronic vouchers is configured to exchange a predetermined amount of virtual currency.

15. The device of claim 10, wherein the at least one processor assigning the corresponding amount of virtual currency to each of the multiple block chain accounts based on the number of special electronic vouchers owned by each of the multiple block chain accounts comprises:
calculating a reward distribution ratio of each of the multiple block chain accounts in a predetermined virtual currency set based on the number of special electronic vouchers owned by each of the multiple block chain accounts; and
assigning the corresponding amount of virtual currency to each of the multiple block chain accounts based on the reward distribution ratio of each of the multiple block chain accounts.

16. The device of claim 10, wherein each of the special electronic vouchers corresponds to one reward distribution request, the at least one processor assigning the corresponding amount of virtual currency to each of the multiple block chain accounts based on the number of special electronic vouchers owned by each of the multiple block chain accounts comprises:
assigning a random amount of virtual currency from a predetermined virtual currency set to each of the multiple block chain accounts based on the reward distribution request.

17. The device of claim 10, wherein each of the special electronic vouchers comprise a unique serial number, the at least one processor determining the special electronic vouchers with the authority of reward distribution according to the predetermined extraction rule comprises:
extracting one or more serial numbers with the authority of reward distribution according to a predetermined random number generation algorithm; and
defining electronic vouchers comprised extracted serial numbers as the special electronic vouchers.

18. The device of claim 10, wherein the at least one processor determining the special electronic vouchers with the authority of reward distribution according to the predetermined extraction rule comprises:
calculating a hash value of each of the electronic vouchers;
extracting one or more hash values with the authority of reward distribution according to a predetermined random number generation algorithm; and
defining electronic vouchers corresponding to extracted hash values as the special electronic vouchers.
